(19) United States
(12) Patent Application Publication
(10) Pub. No.: US 2016/0264062 A1
(43) Pub. Date: Sep. 15, 2016

(54) Entertainment System and Method for a Luxury Vehicle

(71) Applicant: Frank Hodges, Corona, CA (US)

(72) Inventor: Frank Hodges, Corona, CA (US)

(21) Appl. No.: 15/067,962

(22) Filed: Mar. 11, 2016

Related U.S. Application Data
(60) Provisional application No. 62/131,819, filed on Mar. 11, 2015.

(51) Int. Cl. B60R 11/02

(52) U.S. Cl. CPC B60R 11/0235; B60R 2011/0276; B60R 2011/0003

(57) ABSTRACT

An entertainment system for a luxury vehicle that is mounted in a partition that separates a driver from a back seat passenger. The partition provides privacy and the ability to encase large television screens or monitors. The mounted monitor can be lowered to allow for communication with a driver or let the passenger see out the windshield.

### CROSS-REFERENCE TO RELATED APPLICATION

U.S. provisional application No. 62/131,819 dated Mar. 11, 2015 the contents of which are hereby incorporated by reference.

### FIELD OF THE INVENTION

The present invention is in the field of mobile entertainment systems and methods of manufacturing for luxury executive vehicles.

### BACKGROUND

Many present day in-vehicle entertainment systems include an in-dash mounted radio frequency (RF) receiver, CD/DVD player, and a universal serial bus (USB) port for the system to download program source data from a thumb drive or similar memory device. A vehicle passenger may use portable electronic device (PED) such as smart phone, tablet, or media player (e.g. an I-POD®) to access program source data previously stored on the PED. Entertainment systems for automobiles are well known. As such, many advances have been made in the development of entertainment systems that make the otherwise tedious task of riding in an automobile almost bearable. In addition to the development of overhead systems pioneered by the present inventor, a variety of systems and techniques for integrating entertainment systems within an automobile have been developed.

Limitation to the modification to accommodate in a custom vehicle. Not going to try to invent 48 inch in a standard vehicle. Modify without making the modification obvious from the outside. From average observer perspective the outside is not modified, the width is not modified. The height is modified to accommodate.

For example, headrest entertainment systems have been developed and allow multiple individuals to view a variety of different video sources within the same vehicle. However, some automobiles are not suited for the utilization of headrest entertainment systems and, therefore, are unable to take advantage of this advancement in technology. Similarly, only larger vehicles can take advantage of the overhead systems commonly found in automobiles. But even these do not make entertainment centers for luxury travel.

With this in mind, alternate techniques for implementing entertainment systems within automobiles are needed. The present invention attempts to add to the choices consumers have by providing an automobile entertainment system that can give the user a “wow” experience.

Although various improvements are known to the art, all, or almost all of them suffer from one or more than one disadvantage. Therefore, there is a need to provide an improved entertainment system and method of installation in executive vehicles.

### RELEVANT ART REFERENCES

U.S. Pat. No. 5,918,183 issued to Jansky et al., discloses a concealed mobile communications system.

U.S. Pat. No. 7,163,251 issued to Sitzler et al., discloses a seat back storage system for a vehicle entertainment system.

U.S. Pat. No. 7,604,291 issued to Vitito discloses a vehicle entertainment system incorporated within the armrest/console of a vehicle with a swivel monitor mounting structure.

U.S. patent application Ser. No. 10/225,674 disclosed by lmamura et al., discloses an in-vehicle monitor support structure.

U.S. patent application Ser. No. 11/874,684 disclosed by Revelino et al., discloses a flat screen television bracket for a vehicle.

U.S. patent application Ser. No. 11/571,223 disclosed by Handa discloses a panel driven apparatus.

U.S. patent application Ser. No. 13/652,566 disclosed by Kelly disclosed an in-vehicle entertainment system for providing program source data to a portable electronic device.

These publications and all other referenced patents are incorporated herein by reference in their entirety. Furthermore, where a definition or use of a term in a reference, which is an incorporated reference here, is inconsistent or contrary to the definition of that term provided herein the definition of the term provided herein applies and the definition of that term in the reference does not apply.

### SUMMARY OF THE INVENTION

In view of the shortcomings of the prior art, it is the object of this invention to provide an awesome entertainment center in a vehicle without completely customizing a mobile movie theater.

It is further an object of the invention that the installation be performed with a skilled crew but that the current disclosure be sufficient for one skilled in the art to achieve awesome results.

It is further an object of the invention that the system be mobile.

It is to be understood that the foregoing general description and the following detailed description are exemplary and explanatory only and are not to be viewed as being restrictive of the present invention, as claimed. Further advantages of this invention will be apparent after a review of the following detailed description of the disclosed embodiments and in the appended claims.

### BRIEF DESCRIPTION OF THE DRAWINGS

FIG. 1 shows a preferred embodiment of a frame for installing into a sport utility vehicle modified for receiving a monitor flat screen of fifty inches measured by the diagonal.

FIG. 2 shows a preferred embodiment of a frame for installing into a sport utility vehicle modified for receiving a monitor flat screen of fifty inches measured by the diagonal in the raised position.

FIG. 3 shows a preferred embodiment of a frame for installing into a sport utility vehicle modified for receiving a monitor flat screen of fifty inches measured by the diagonal in the raised position.

FIG. 4 shows a preferred embodiment of a frame installed into a sport utility vehicle modified for receiving a monitor flat screen of fifty inches measured by the diagonal.

FIG. 5 shows a preferred embodiment of a frame for installing into a sport utility vehicle modified for receiving a monitor frame between a driver seat and passenger seat.

FIG. 6 shows a preferred embodiment of a frame installed into a van for receiving a monitor flat screen.

FIG. 7 shows a preferred embodiment of a frame for installing into a van for receiving a monitor frame between a driver seat and passenger seat.

### DETAILED DESCRIPTION OF THE EMBODIMENTS

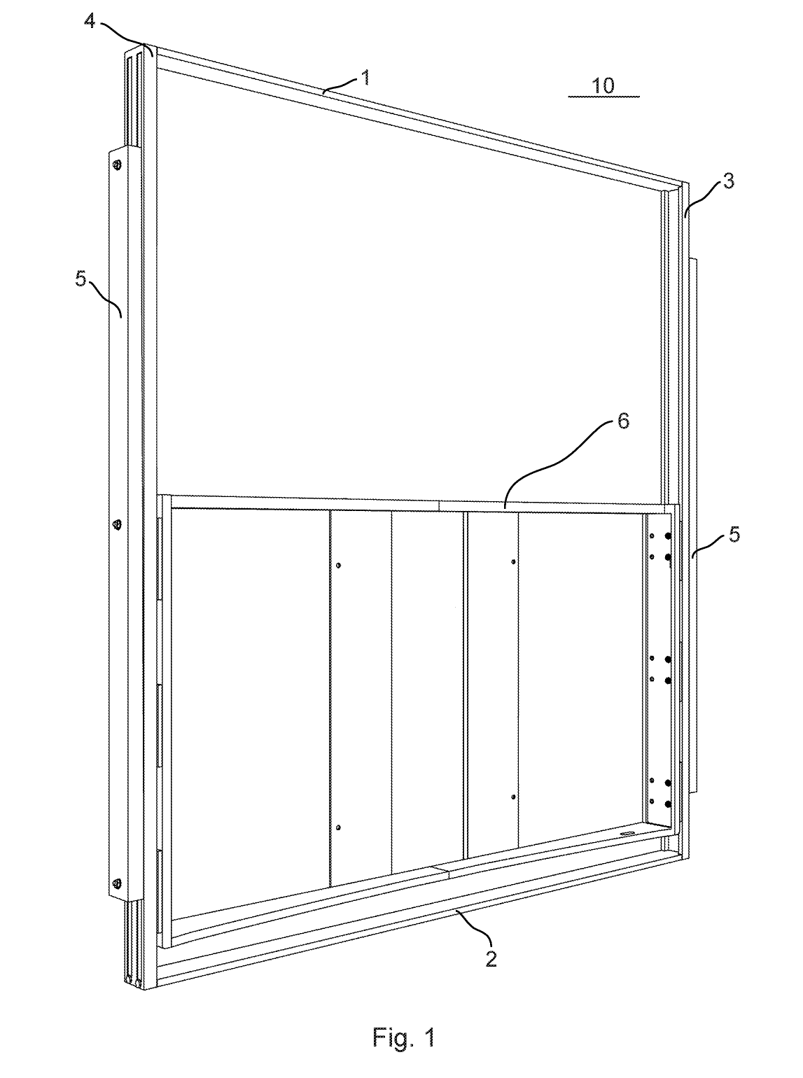

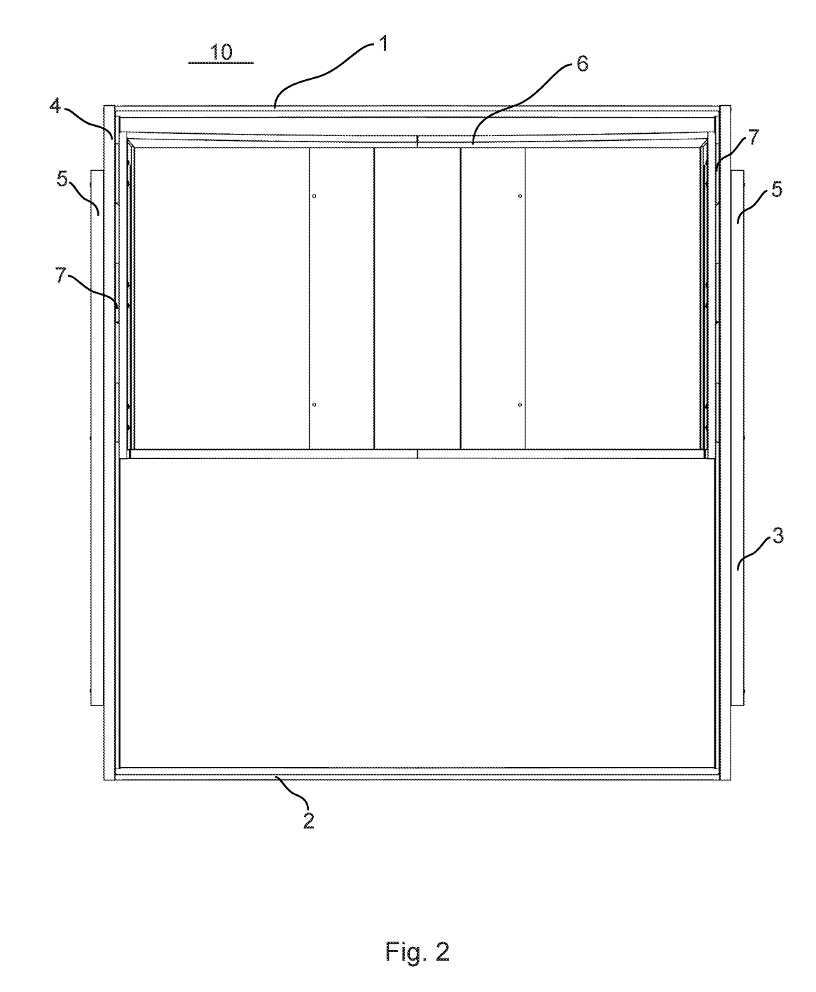

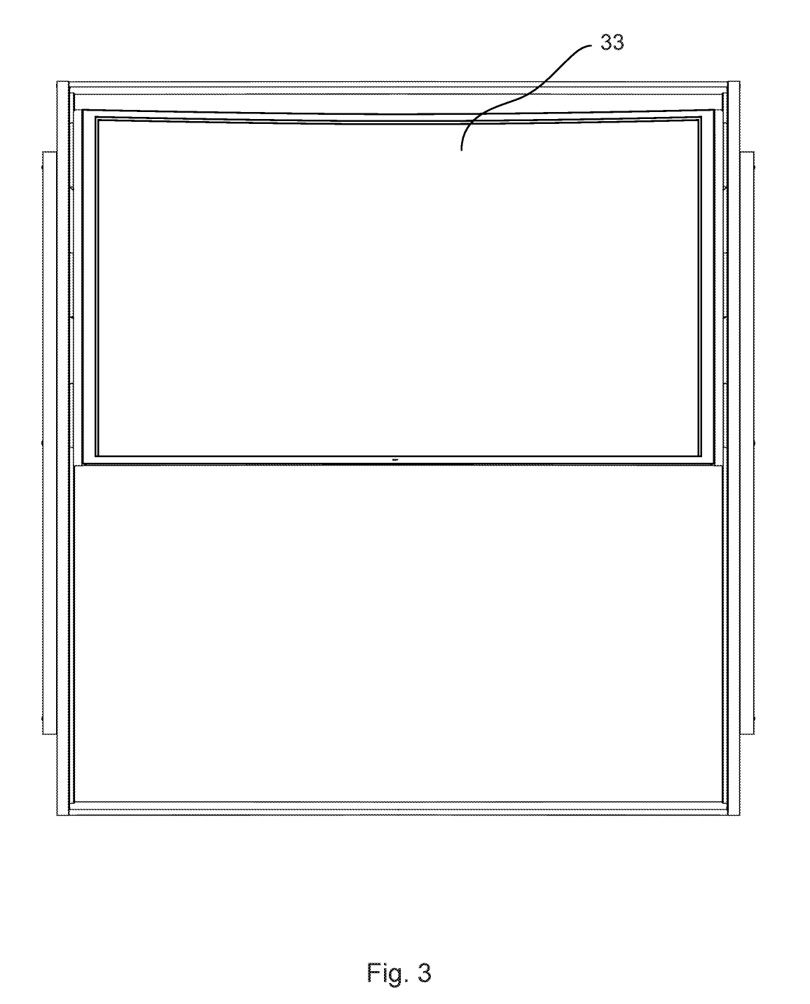

Referring now to the drawings wherein the showings are for purposes of illustrating a preferred embodiment of the present invention and not for purposes of limiting the same, A first embodiment of the invention is a monitor frame adapted for insertion into a vehicle. The frame may be made of various materials comprising metal, polymer, and wood to achieve a strong, light weight, and sturdy support for a monitor in a moving vehicle. The dimensions are given with respect to accommodate a 48 to 50 inch television in a Cadillac Escalade®. However, additional dimensions are described for different embodiments. The frame 10 is rectangular in shape having a top 1, a bottom 2, a right side 3 and a left side 4. The frame 10 is mountable to a vehicle via frame mounts 5 that provide a fixed and stable platform for the frame 10 to attach to a vehicle. The vehicle frame 10 has a monitor mount 6 that is generally rectangular and is mounted to at least one vertical guide member 7 between the sides of the frame 10 and the monitor mount 6 of the vehicle frame 10. The vertical guide member 7 provides a platform for the monitor mount 6 to raise and lower with in the vehicle frame 10. The monitor mount 6 is operable via an electric motor to raise and lower depending upon an Executive's operating preferences. See FIGS. 1-3. FIG. 2 shows a preferred embodiment in the open position and FIG. 3 shows a preferred embodiment in the closed position wherein a monitor is in a viewable position.

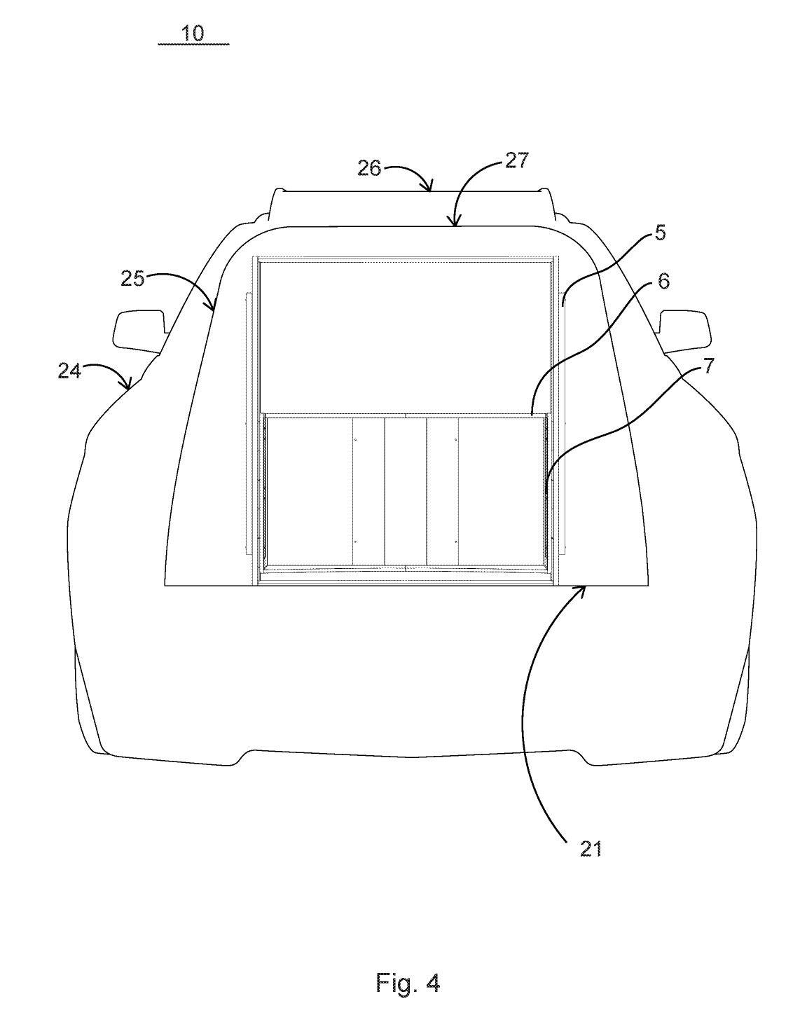

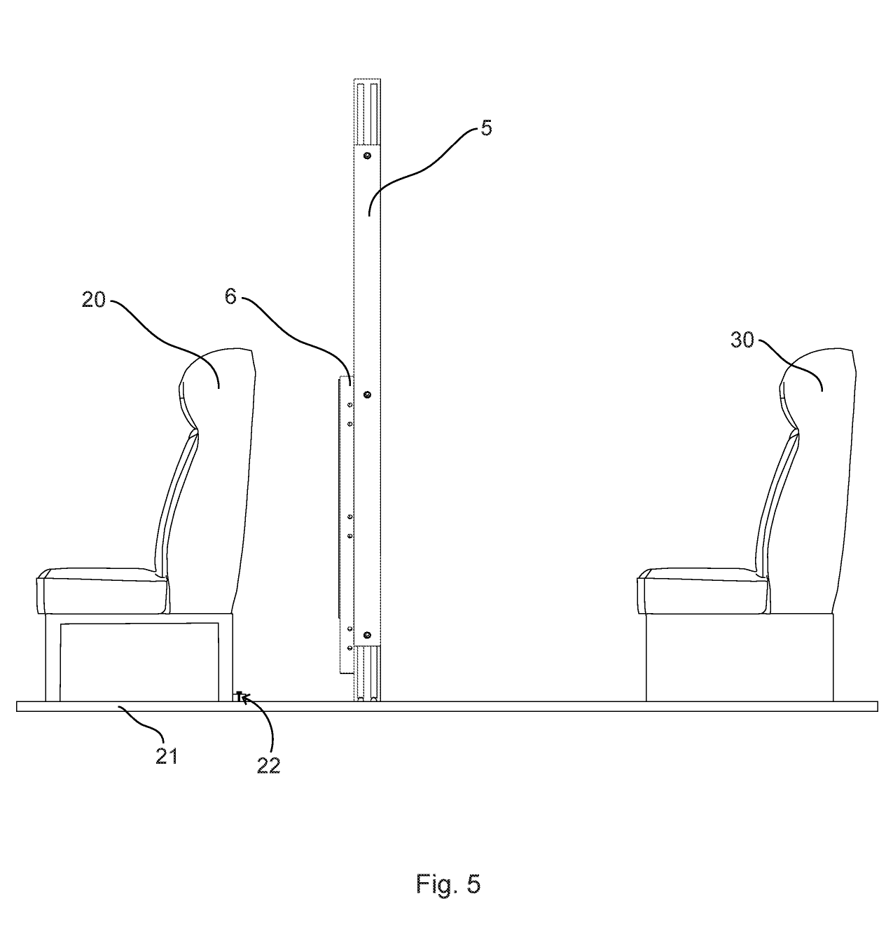

FIGS. 4 and 5 show a vehicle frame 10 maybe further be incorporated into a partition or divider between a driver seat 20 and a passenger seat 30 of an SUV vehicle. When the monitor mount 6 is in the closed position the driver cannot directly visualize any executives in a passenger portion of the vehicle. A driver would have to utilize an audio or audio and visual communication means like speakers and or video feed to communicate with an executive when the monitor mount 6 is in the closed position. This provides a measure of privacy and security to the executive. For example, the executive could turn off audio monitoring with the driver for private conversations in the vehicle or for phone calls or for teleconference calls on a monitor mounted on the monitor mount 6. Alternatively, an executive could open the partition between the driver portion and passenger portion of a vehicle by operating the monitor mount 6 to secrete into a partition and thus open a fluid space between the executive and the driver to communicate directly. In a preferred embodiment the driver seat 20 is mounted to the floor 21 of a sport utility vehicle (“SUV”) and in particular the rear mount hole 22 is used to bolt the driver's seat. A partition (not shown in FIG. 5) with a decorative facade encapsulates frame 10 and is located between five inches and thirty inches away from the rear mount hole 22. In order to accommodate a large monitor the SUV ceiling must be adapted such as by raising six inches on the roof exterior 26 and interior ceiling 27. In an SUV preferred embodiment it is sometimes necessary to raise the roof exterior 26 and interior ceiling 27 but this relatively modest modification allows the vehicle to accommodate a relatively large monitor of fifty inches without the need to augment or modify the side exterior panels 24 or side interior 25. This modification limited to the roof exterior 26 and interior ceiling 27 keeps the cost of manufacture relatively inexpensive and complies with Department of Transportation regulations. FIG. 5 shows a profile of an SUV interior. In a preferred embodiment a driver seat 20 is bolted to an SUV floor 21 via a bolt in bolt hole 22. A passenger seat 30 would be mounted to the SUV floor in a conventional manner. A partition housing a monitor frame 10 would be positioned between the driver portion and passenger portion of the SUV. In a preferred embodiment the frame mounts 5 would be positioned between five and thirty inches from the bolt hole 22 of a driver seat 20 in a vehicle. For the sake of clarity it is intended that a monitor 33 be firmly attached to or within the monitor mount 6. In the preferred embodiment the monitor 33 would be at least twenty inches above the SUV floor 21 to be visible and no more than six inches from the interior ceiling 27. FIG. 5 shows center of the rear bolt hole 22 of the driver seat 20. Additionally, frame sides 3,4 are disposed between two and fourteen inches from an SUV side interior 25.

FIGS. 1-3 show the frame and dimensions for a preferred embodiment that includes the installation into a vehicle with an unmodified width and a modified height of between three to six inches to accommodate a fifty inch monitor in a partition between a driver portion and an executive portion. While in the closed position the frame supports the monitor in a viewable position that blocks off visual communication between the driver and executive unless other video camera means are used. While in the open position the frame is secreted in the partition so that an executive and a driver could communicate the same as a common person would in a taxi cab.

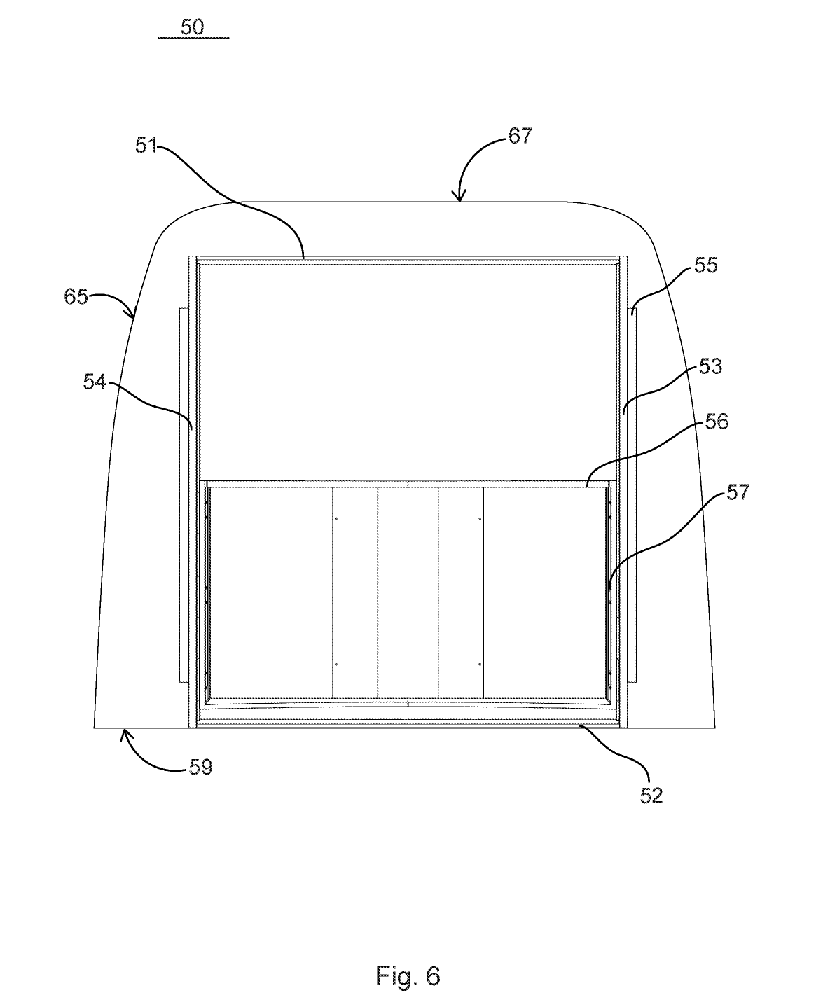

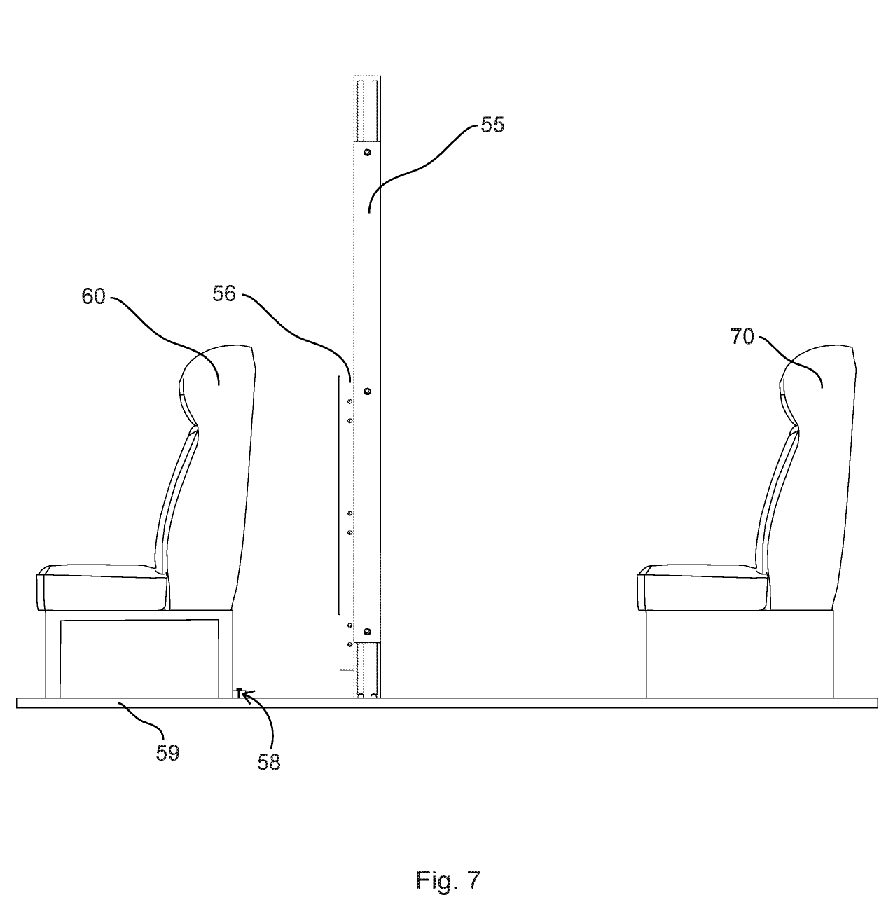

FIGS. 6 and 7 show an alternative embodiment of the present invention, a roof modification is not needed for a van, for example a Mercedes Benz Sprinter® has a relatively high roof 67 compared to a typical SUV. The frame 50 is rectangular in shape having a top 51, a bottom 52, a right side 53 and a left side 54. The frame 50 is mountable to a vehicle via frame mounts 55 that provide a fixed and stable platform for the frame 50. The vehicle frame 50 has a monitor mount 56 that is generally rectangular and is mounted to at least one vertical guide member 57 between the sides of the frame 50 and the monitor mount 56 of the vehicle frame 50. The vertical guide member 57 provides a platform for the monitor mount 56 to raise and lower with in the vehicle frame 50. The monitor mount 56 is operable via an electric motor to raise and lower depending upon an Executive's operating preferences.

The vehicle frame 50 maybe further incorporated into a partition or divider between a driver portion and a passenger portion of a vehicle. When the monitor mount 56 is in the closed position the driver cannot directly visualize any executives in a passenger portion of the vehicle. A driver would have to utilize an audio or audio and visual communication means like speakers and or video feed to communicate with an executive when the monitor mount 56 is in the closed position. This provides a measure of privacy and security to the executive. For example, the executive could turn off audio monitoring with the driver for private conversations in the vehicle or for phone calls or for teleconference calls on a monitor mounted on the monitor mount 56. Alternatively, an executive could open the partition between the driver portion and passenger portion of a vehicle by operating the monitor mount 56 to secrete into a partition and thus open a fluid space between the executive and the driver to communicate directly. In a preferred embodiment the driver seat 60 is mounted to the floor 59 of a van and in particular the rear mount hole 58 is used to bolt the driver seat 60. A partition (not shown in FIG. 7) with a decorative facade encapsulates frame 50 and is located between five inches and thirty inches away from the rear mount hole 58. In order to accommodate a large monitor the van ceiling 67 need not be modified. FIG. 7 shows a profile of a van interior. In a preferred embodiment a driver seat 60 is bolted to a van floor 59 via a bolt in bolt hole 58. A passenger seat 70 would be mounted to the van floor 59 in a conventional manner. A partition housing a monitor frame 50 would be positioned between the driver seat 60 and passenger seat of the van. In a preferred embodiment the frame mounts 5 would be positioned between five and thirty inches from the bolt hole 22 of a driver seat 20 in a vehicle. For the sake of clarity it is intended that a monitor 33 be firmly attached to or within the monitor mount 56. In the preferred embodiment the monitor 33 would be at least twenty inches above the van floor 59 to be visible and no more than twenty four inches from the interior ceiling 67. FIG. 7 shows center of the rear bolt hole 58 of the driver seat 60. Additionally, frame sides 53,54 are disposed between two and fourteen inches from a van interior side 65.

A partition and monitor frame 50 can be adapted to hold curved or flat monitors by simply adjusting the thickness of the frame. The Sprinter® is capable of having a seventy inch monitor without having to modify the interior side 65 of the vehicle. The monitor frame 50 in a Sprinter® would be mounted between one and twelve inches from the vehicle interior side 65 or for example from a passenger window. In the Sprinter® embodiment the top of the monitor viewable portion would be limited to between one inch to twenty-four inches from the ceiling of the vehicle. The monitor frame in a typical SUV would be between four and thirteen inches from a passenger window without the vehicle sides being modified.

Monitors are used for watching movies, security cameras, conference calling and other entertainment.

Vertical guides can be made of simple rail systems the purpose of the vertical guides is to provide a stable platform to raise and lower the monitor frame. The vertical guides can be made of metal, wood, or polymer, or in combination thereof. The vertical guides may have chains, tracks, wires or other attachment means to allow low friction movement of the monitor mount between the monitor left and right sides.

The foregoing description is, at present, considered to be the preferred embodiments of the present discovery. However, it is contemplated that various changes and modifications apparent to those skilled in the art, may be made without departing from the present discovery. Therefore, the foregoing description is intended to cover all such changes and modifications encompassed within the spirit and scope of the present discovery, including all equivalent aspects. Additional modifications and improvements of the present invention may also be apparent to those skilled in the art. Thus, the particular combination of parts described and illustrated herein in intended to represent only one embodiment of the invention, and is not intended to serve as limitations of alternative devices within the spirit and scope of the invention.

I claim:

1. A vehicle monitor frame that is incorporated into a partition and can raise and lower a monitor mount so that the monitor mount is viewable by a person in a passenger seat wherein the monitor mount is disposed between five and thirty inches behind a driver seat bolt hole.

2. The vehicle monitor frame of claim 1 wherein the monitor is 42-50 inches measured on the diagonal.

3. A method of installing a monitor into a vehicle wherein the width of a vehicle remains stock and only a portion of a roof of the vehicle is raised by six inches or less to accommodate a 42-50 inch monitor.

4. A method of installing a monitor into an SUV wherein the monitor is mounted on a retractable partition that is between five and thirty inches from the rear bolt of a driver's seat.

5. A method of installing a monitor into an SUV wherein the monitor is mounted on a retractable partition that is between five and thirty inches from the rear bolt of a driver's seat and the viewable portion of the monitor is at least twenty inches above the SUV floor.

6. A method of installing a monitor into an SUV wherein the monitor is mounted on a retractable partition that is between five and thirty inches from the rear bolt of a driver's seat and the viewable portion of the monitor is at least twenty inches above the SUV floor and the viewable portion of the monitor in between one and five inches below the SUV ceiling.
